(19) United States
(12) Patent Application Publication
(10) Pub. No.: US 2015/0345825 A1
(43) Pub. Date: Dec. 3, 2015

(54) Water Supply and Heating System Comprising Flexible Tank and Heating Unit

(71) Applicant: EZ PACK WATER LTD, Savion (IL)

(72) Inventor: Alex Harel, Savion (IL)

(73) Assignee: EZ PACK WATER LTD, Savion (IL)

(21) Appl. No.: 14/758,478

(22) PCT Filed: Jan. 7, 2014
(86) PCT No.: PCT/IL2014/000003

§ 371 Date: Jun. 29, 2015

(30) Foreign Application Priority Data
Jan. 8, 2013 (IL) 224132

(51) Int. Cl. F24H 1/06; F24H 1/18; F24H 1/08

(52) U.S. Cl. CPC F24H 1/06; F24H 1/08; F24H 1/185

(57) ABSTRACT

A water supply system comprises a flexible water tank and a water heating unit. The flexible water tank comprises an outer layer, an inner layer, and an isolating layer in between the two The outer layer is made of a strong and flexible material and the inner layer is made of a food-safe material. The water heating unit comprises a mechanism for connection to the power source and electrical heating strips that are attached to the inner layer of the flexible water tank.

### TECHNICAL FIELD

The present invention refers to a system for the supply and heating of water, which comprises a flexible water tank and a water heating unit with electrical heating strips.

### BACKGROUND ART

In many instances it is customary to use systems for the supply and heating of water for residential, industrial, and agricultural use. Currently existing systems are cumbersome and are based primarily on rigid, heavy water tanks that are inconvenient to transport and set up in the desire location. In many cases, users need a water supply and heating system that is portable and lightweight, and easy to connect and operate. The present invention describes a water supply and heating system with unique and innovative features that provides a response to these problems.

### DESCRIPTION OF THE DRAWINGS

The intention of the drawings attached to the application is not to limit the scope of the invention and its application. The drawings are intended only to illustrate the invention and they constitute only one of its many possible implementations.

FIG. 1 presents a schematic view of the system (1), which includes a flexible water tank (2), a water inlet (51) and outlet (52), a photoelectric panel (41), a flexible solar collector (42), an electrical connection mechanism (32), and a temperature controller (33).

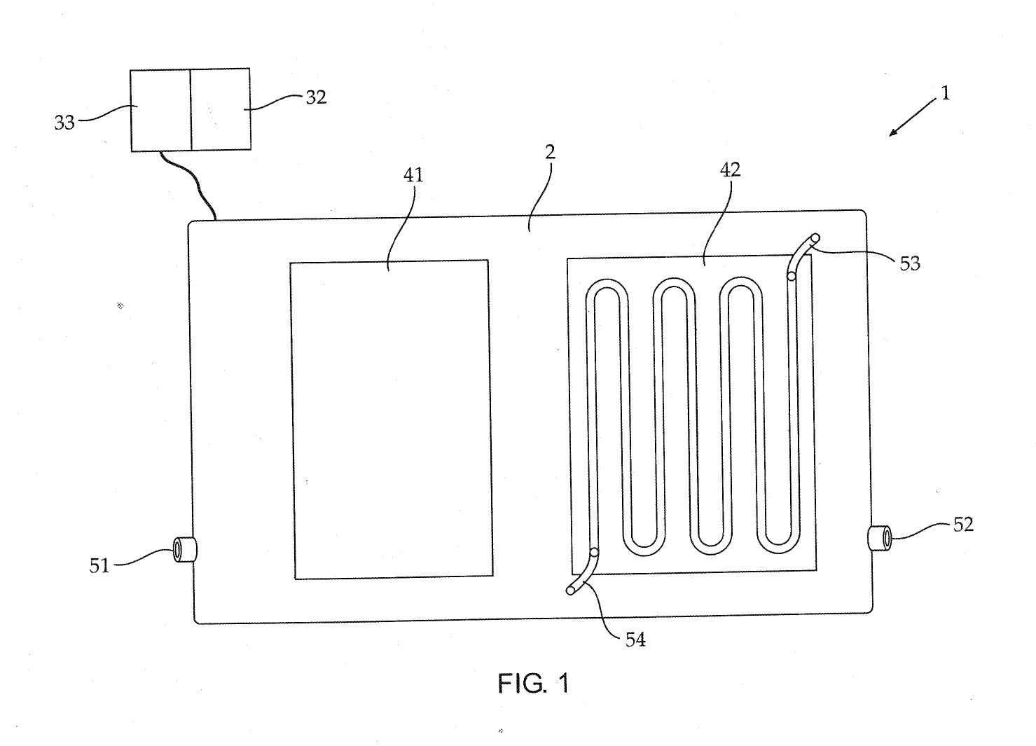

FIG. 2 presents a schematic side view of the flexible water tank (2) showing the three layers (21) (22) (23) and a top section showing the inner layer (22) to which electrical heating strips (31) are attached.

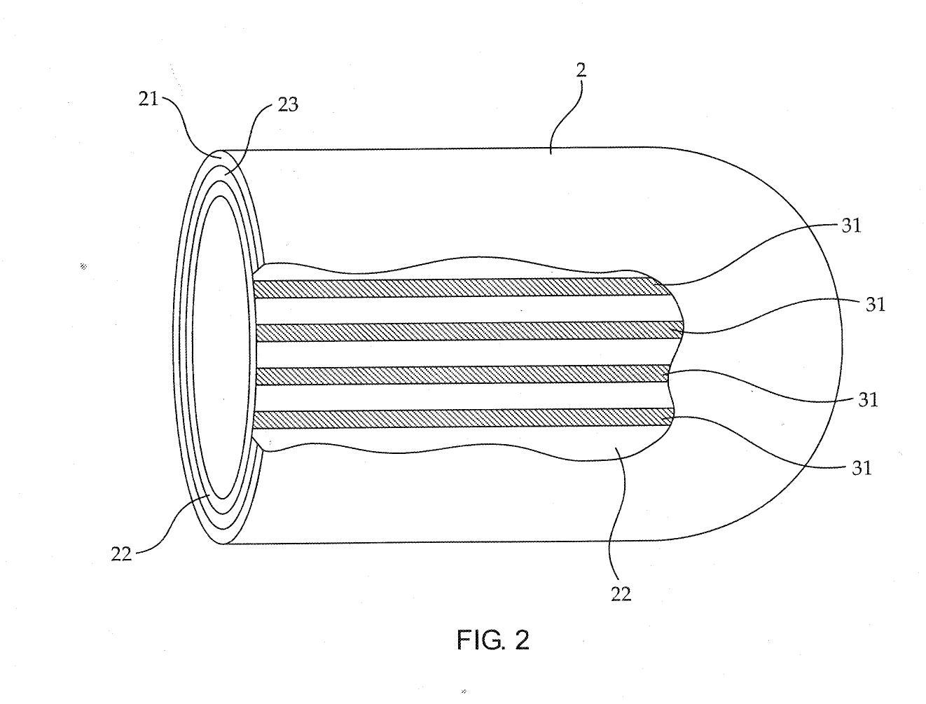

### THE INVENTION

The primary objective of the present invention is to provide a water supply system that comprises a flexible water tank and a water heating unit with electrical heating strips. Another objective of the present invention is to provide the said system whereby the flexible tank comprises a strong, flexible outer layer, a flexible inner layer that can be made of a food-safe material, and an isolating layer in between the two. A third objective of the invention is to provide the said system whereby the electrical heating strips fully or partially surround the inner layer of the flexible tank, leading to higher energy efficiency of the system. A fourth objective of the present invention is to provide the said system whereby the water may be heated by any one of several energy sources. Yet another objective of the present invention is to provide the said system whereby it can be conveniently transported and set up at the relevant site and easily connected to the water system at the said site.

The water supply and heating system (1) (hereinafter “the system”) comprises a flexible water tank (2) with three layers: a strong, flexible outer layer (21), a food-safe inner layer (22), and an insulating layer (23); a water heating unit (3) that comprises electrical heating strips (31); a command and control mechanism and electrical connections (32); a temperature controller with a thermometer (33); a photoelectric panel (41); and a flexible or rigid solar collector (41) for heating water using solar energy.

As mentioned, the water tank (2) comprises an outer layer (21), an inner layer (22), and an insulating layer (23). The outer layer (21) can and should be made of a material such as PVC, PE or some other material that is flexible enough to enable the tank (2) to inflate when it is filled with water and deflate when the water is drained from it. The material must also be strong enough so that the outer layer does not tear under the weight of the water or upon contact or impact with other objects or with the ground when the system (1) is in use or is being transported to its required location. The outer layer (21) of the flexible water tank (2) should also be dark, preferably black, so as to maximize absorption of heat from the sun to help heat the water in the tank. The inner layer (22) can and should be made of a food-safe material, i.e. a material approved by the relevant authorities for storing potable fluids. The insulating layer (23) can be made of any known and existing insulating material.

The water heating unit (3) is designed to heat the water in the tank (2) using electrical heating strips (31) that are attached to the inner layer (22) in such a way that leads to high energy efficiency.

The electrical strips (31) are connected to an external power source that provides them with electricity. The power source can be the conventional electricity grid or a generator, or the photoelectric panel (41) that utilizes solar energy to produce electricity that is then used to heat the water in the tank. The electrical connection mechanism (32) includes an electronic card and an electrical circuit designed to connect the electrical strips (31) to the said power source and control the relevant power source so that it may be turned on at any given moment according to need.

The flexible solar collector (42) is similar to currently known rigid solar collectors used on solar water heaters, but in this case it is made of flexible materials and pipes so that it can be positioned and coupled conveniently and easily to or near the flexible water tank (2).

Connecting the system (1) to relevant water and power sources: The tank (2) has a water inlet (51) to which the water inlet pipe is connected; a hot water outlet (52) through which the water leaves the tank and flows in a pipe to its relevant destination; a water inlet pipe (53) that supply the tank (2) with hot water from the flexible solar collector (42); an outlet pipe (54) that recirculates water from the tank (2) back into the flexible solar collector (42); and electrical connections that connect the photoelectric panel to the system (1) via the electrical connection mechanism (32).

Adapting the system (1) to existing solar heaters: The system (1) can be connected directly to rigid solar collectors that are already installed on many buildings instead of, or in addition to connecting the flexible solar collector (42) to the tank (2). The system (1) with its flexible tank (2) can serve as an alternative for existing solar heaters. Using the system (1) instead of an existing solar heater offers many advantages: (a) The system (1) and the tank (2) are lightweight and small in terms of volume and can be transported and set up in the relevant location easily and safely, as opposed to rigid tanks which are heavy and cumbersome and unsafe to transport and set up on roofs; (b) scale does not accumulate on the flexible tank (2) since the heating strips do not come in direct contact with the water; and (c) if, nevertheless, scale should accumulate on the inner layer (22) of the tank (2), the said inner layer (22) may be replaced easily and relatively inexpensively.

Using the system (1) in agriculture: On days, and especially on nights of frost, farmers prevent plants from freezing and dying by irrigating their crops with water that is warm relative to ambient temperatures. For example, when the ambient temperature is 2° C., irrigating with water at 9° C. is considered to be an excellent solution for crops. Thus, when the forecast is frost, the farmer can transport the system (1) to the desired location, set the system (1) up, connect it to appropriate power and water systems, fill the tank (2), activate the water heating unit (3), and irrigate the crop at the required time.

Using the system (1) to prevent freezing of water in main water pipes: In cold places where external water tanks are used for the supply of water, systems are required in order to prevent water from freezing when ambient temperatures drop beneath the freezing point. In addition, in such areas as described above, even when water is supplied via standard water piping, there are times when it is so cold that water freezes in the pipes. The system (1), subject of the present invention, offers an effective response to this problem by connecting the system to the water and power systems, activating the heating unit (3), and circulating warm water through the piping to prevent freezing.

The system (1), subject of the present invention, can be transported, set up, and connected in an easy and fast manner at the intended site; the flexible tank (2) can be replaced by another flexible tank of different volume without involving any of the other system components; the system (1) includes a water heating unit (3) that can be powered by a variety of energy sources; the flexible tank (2) can be almost any size, up to a volume of several thousand liters and more; the system (1) is portable and can be transported from place to place according to need, or can be set up in one location for extended use. No similar water supply and heating system currently exists that, like the system (1), subject of the present invention, offers the advantages and solutions mentioned above. The system (1) described above constitutes a good, efficient, and inexpensive response to the needs described in the application in general.

Drawing No. 1 presents a schematic view of the system (1), which includes a flexible water tank (2), a water inlet (51) and outlet (52), a photoelectric panel (41), a flexible solar collector (42), an electrical connection mechanism (32), and a temperature controller (33).

Drawing No. 2 presents a schematic side view of the flexible water tank (2) showing the three layers (21) (22) (23) and a top section showing the middle layer (22) to which electrical heating strips (31) are attached.

What is claimed is:

1. A water supply system that includes a flexible water tank and a water heating unit; wherein the flexible water tank comprises an outer layer, an inner layer, and an insulating layer; wherein the said outer layer is made of a strong and flexible material; and wherein the insulating layer is situated between the said outer and inner layers; wherein the water heating unit includes electrical heating strips that are attached to the said inner layer of the said tank as well as a mechanism for connection to the power system.

2. The system mentioned in claim No. 1 wherein it also includes a photoelectric panel and/or a flexible and/or rigid solar collector and wherein it includes connections to existing solar collectors.

3. The system mentioned in claim No. 1 wherein the inner layer is made of a food-safe material.

4. The system mentioned in claim No. 1 wherein the water heater is fully or partially powered by electricity produced by flexible or rigid photo-voltaic cells that are mounted on the tank itself.
